(19) United States
(12) Patent Application Publication
(10) Pub. No.: US 2026/0003236 A1
(43) Pub. Date: Jan. 1, 2026

(54) ELECTRO-OPTICAL DEVICE AND ELECTRONIC APPARATUS

(71) Applicant: SEIKO EPSON CORPORATION, Tokyo (JP)

(72) Inventor: Yuki YASHIRO, CHITOSE-SHI (JP)

(73) Assignee: SEIKO EPSON CORPORATION, Tokyo (JP)

(21) Appl. No.: 19/249,972

(22) Filed: Jun. 25, 2025

(30) Foreign Application Priority Data
Jun. 27, 2024 (JP) 2024-103851

(51) Int. Cl. G02F 1/1362; G02F 1/1368

(52) U.S. Cl. CPC G02F 1/136209; G02F 1/1368

(57) ABSTRACT

An electro-optical device includes: a first substrate; a second substrate; an electro-optical layer disposed between the first substrate and the second substrate; a display region including a plurality of pixels; and a peripheral area provided outside the display region, in which the first substrate includes: a transmission gate including an N-channel type transistor and a P-channel type transistor; an electrical conducting section closer to the electro-optical layer than the transmission gate; and a light shielding film closer to the electro-optical layer than the electrical conducting section, and the light shielding film overlaps with the electrical conducting section and one of the N-channel type transistor and the P-channel type transistor in plan view, and does not overlap with the other one of the N-channel type transistor and the P-channel type transistor in plan view.

The present application is based on, and claims priority from JP Application Serial Number 2024-103851, filed Jun. 27, 2024, the disclosure of which is hereby incorporated by reference herein in its entirety.

### BACKGROUND

### 1. Technical Field

The present disclosure relates to an electro-optical device and an electronic apparatus.

### 2. Related Art

For example, an electro-optical device such as a liquid crystal display device that can change an optical property for each pixel is used in an electronic apparatus such as a projector.

JP-A-2018-63318 discloses a device including a plurality of pixel circuits and a peripheral circuit configured to drive and control the plurality of pixel circuits. The peripheral circuit is provided with a transistor, a wiring line disposed at the upper layer of the transistor, and a light shielding film disposed at the upper layer of the wiring line and configured to block the light entering the transistor. In addition, the light shielding film is provided so as to cover the entire region of the transistor in plan view.

Description will be made of a case where a transmission gate including an N-channel type transistor and a P-channel type transistor is used as the transistor. In this case, when the light shielding film covers the entire region of the transmission gate in plan view, individual capacitive couplings formed between the light shielding film and wiring lines for an N-channel type transistor and a P-channel type transistor are equivalent. Thus, when there is a difference in performance between the N-channel type transistor and the P-channel type transistor, it is not possible to eliminate the difference in performance between them. When the difference in performance is large, there is a problem in that it is difficult to drive the electro-optical device at high speeds.

### SUMMARY

One aspect of an electro-optical device according to the present disclosure includes a first substrate, a second substrate, an electro-optical layer disposed between the first substrate and the second substrate, a display region including a plurality of pixels, and a peripheral area provided outside the display region, in which the first substrate includes a transmission gate including an N-channel type transistor and a P-channel type transistor, an electrical conducting section closer to the electro-optical layer than the transmission gate, and a light shielding film closer to the electro-optical layer than the electrical conducting section, and the light shielding film overlaps with one of the N-channel type transistor and the P-channel type transistor in plan view, and does not overlap with the other one of the N-channel type transistor and the P-channel type transistor in plan view.

One aspect of an electro-optical device according to the present disclosure includes a first substrate, a second substrate, an electro-optical layer disposed between the first substrate and the second substrate, a display region including a plurality of pixels, and a peripheral area provided outside the display region, in which the first substrate includes a transmission gate including an N-channel type transistor and a P-channel type transistor, an electrical conducting section closer to the electro-optical layer than the transmission gate, a first light shielding film closer to the electro-optical layer than a wiring line, and a second light shielding film closer to the electro-optical layer than the electrical conducting section, the first light shielding film overlaps with the N-channel type transistor in plan view, the second light shielding film overlaps with the P-channel type transistor in plan view, and either one of the first light shielding film and the second light shielding film has a light shielding property lower than a light shielding property of the other one.

One aspect of an electronic apparatus according to the present disclosure includes the electro-optical device, and a control unit configured to control operation of the electro-optical device.

### BRIEF DESCRIPTION OF THE DRAWINGS

FIG. 1 is a plan view illustrating an electro-optical device according to a first embodiment.

FIG. 2 is a cross-sectional view taken along the line A-A of the electro-optical device illustrated in FIG. 1.

FIG. 3 is an equivalent circuit diagram illustrating an electrical configuration of each pixel in FIG. 1.

FIG. 4 is a diagram illustrating an electrical configuration of each peripheral circuit illustrated in FIG. 1.

FIG. 5 is a plan view illustrating a configuration of a transmission gate illustrated in FIG. 4.

FIG. 6 is a diagram corresponding to the cross section taken along the B1-B1 line in FIG. 5.

FIG. 7 is a diagram corresponding to the cross section taken along the B2-B2 line in FIG. 5.

FIG. 8 is a diagram illustrating the light shielding film illustrated in FIGS. 6 and 7.

FIG. 9 is a diagram illustrating a light shielding film according to a comparative example.

FIG. 10 is a plan view illustrating the layout of a plurality of light shielding sections for a plurality of transmission gates according to the first embodiment.

FIG. 11 is a plan view illustrating the layout of a plurality of light shielding sections for a plurality of transmission gates according to a first modification example.

FIG. 12 is a plan view illustrating a light shielding film according to a second modification example.

FIG. 13 is a cross-sectional view illustrating the light shielding film illustrated in FIG. 12.

FIG. 14 is a diagram illustrating a light shielding film according to a comparative example.

FIG. 15 is a plan view illustrating a first light shielding film and a second light shielding film according to the second embodiment.

FIG. 16 is a cross-sectional view illustrating the first light shielding film and the second light shielding film illustrated in FIG. 15.

FIG. 17 is a plan view illustrating a first light shielding film and a second light shielding film according to a third modification example.

FIG. 18 is a cross-sectional view illustrating the first light shielding film and the second light shielding film illustrated in FIG. 17.

FIG. 19 is a perspective view illustrating a personal computer serving as one example of the electronic apparatus.

FIG. 20 is a plan view illustrating a plan view serving as one example of the electronic apparatus.

FIG. 21 is a schematic view illustrating a projector serving as one example of the electronic apparatus.

### DESCRIPTION OF EMBODIMENTS

Below, preferred embodiments according to the present disclosure will be described with reference to the accompanying drawings. Note that, in the drawings, dimensions or scales of individual portions may differ from actual ones on an as-necessary basis, and there are portions schematically shown to facilitate understanding. Furthermore, in the following description, the scope of the present disclosure is not limited to these modes unless there is a particular statement that limits the present disclosure.

### 1. Electro-Optical Device

### A. First Embodiment

### A1. Basic Configuration

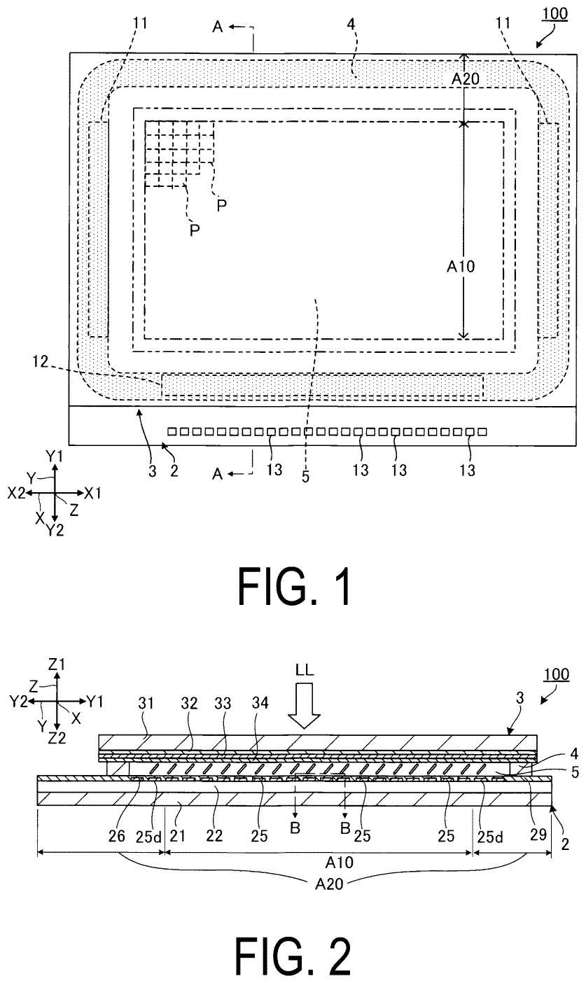

FIG. 1 is a plan view illustrating an electro-optical device 100 according to a first embodiment. FIG. 2 is a cross-sectional view taken along the line A-A of the electro-optical device 100 illustrated in FIG. 1. In addition, below, for the purpose of convenience of explanation, an X-axis, a Y-axis, and a Z-axis orthogonal to each other will be used as appropriate. Furthermore, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z-axis is referred to as a Z1 direction, and a direction opposite to the Z1 direction is referred to as a Z2 direction.

In addition, in this specification, the expression “an element β on an element α” means that the element β is disposed at the upper side of the element α. Thus, the expression “an element β on an element α” includes not only a case where the element β is in direct contact with the element α, but also a case where the element α and the element β are spaced apart from each other. In addition, the expression “electrical coupling” between an element α and an element β includes not only a configuration in which the element α and the element β are electrically conductive by being directly bonded to each other, but also a configuration in which the element α and the element β are electrically conductive indirectly through another conductive body. Furthermore, the expression “equal” includes not only being strictly equal, but also having a difference within a manufacturing error level and within a measurement error level.

The electro-optical device 100 illustrated in FIGS. 1 and 2 is a transmissive-type electro-optical device using an active matrix drive scheme. The electro-optical device 100 includes a first substrate 2, a second substrate 3, a sealing member 4 having a frame shape, and a liquid crystal layer 5. The first substrate 2, the liquid crystal layer 5, and the second substrate 3 are arranged in this order in the Z1 direction, as illustrated in FIG. 2. Note that viewing from the Z1 direction or Z2 direction, which is a direction in which these elements overlap, is referred to as “plan view.” In addition, although the shape of the electro-optical device 100 illustrated in FIG. 1 is a rectangular shape in plan view, the shape may have a polygonal shape or a circular shape other than a rectangular shape.

As illustrated in FIG. 2, the first substrate 2 includes a substrate 21, a stacked body 22, a plurality of pixel electrodes 25, a plurality of dummy pixel electrodes 25d, a peripheral electrode 26, and an orientation film 29. The substrate 21, the stacked body 22, the plurality of pixel electrodes 25, and the orientation film 29 are arranged in this order in the Z1 direction. Note that the “transmissive property” means transmittance to visible light, and preferably indicates that the transmittance to visible light is equal to or more than 50%.

The substrate 21 illustrated in FIG. 2 is a flat plate having a transmissive property and an insulating property, and is comprised of a glass substrate or a quarts substrate, for example. The stacked body 22 has a transmissive property, and includes a plurality of insulating films. In addition, various types of wiring lines or the like are provided at the stacked body 22.

The plurality of pixel electrodes 25, the plurality of dummy pixel electrodes 25d, and the peripheral electrode 26 are disposed at the stacked body 22. The plurality of pixel electrodes 25 apply an electric field to the liquid crystal layer 5. Although not contributing to displaying, the plurality of dummy pixel electrodes 25d have a configuration similar to the plurality of pixel electrodes 25, and are driven and controlled in a manner similar to the plurality of pixel electrodes 25. For example, the plurality of dummy pixel electrodes 25d are used, for example, for measures against noises in image signals written to the plurality of pixel electrodes 25. The peripheral electrode 26 is an ion trapping electrode that traps ionic impurities existing in the liquid crystal layer 5. The plurality of pixel electrodes 25, the plurality of dummy pixel electrodes 25d, and the peripheral electrode 26 each contain a transparent conductive material such as indium tin oxide (ITO), indium zinc oxide (IZO), and fluorine-doped tin oxide (FTO), for example.

The orientation film 29 has a transmissive property and an insulating property. The orientation film 29 causes liquid crystal molecules that the liquid crystal layer 5 includes, to be oriented. The orientation film 29 is disposed so as to cover the plurality of pixel electrodes 25. The orientation film 29 is made of a material such as polyimide or silicon oxide, for example.

The second substrate 3 is disposed so as to be opposed to the first substrate 2. The second substrate 3 includes a substrate 31, an inorganic insulating layer 32, a common electrode 33, and an orientation film 34. In addition, although illustration is not given, the second substrate 3 includes a parting having a light shielding property and configured to surround the plurality of pixel electrodes 25 in plan view. Note that the “light shielding property” means a light shielding property against visible light, and preferably means that the transmittance of the visible light is less than 50%, and more preferably is equal to or less than 10%.

The substrate 31, the inorganic insulating layer 32, the common electrode 33, and the orientation film 34 are stacked in this order in the Z2 direction. The substrate 31 is a flat plate having a transmissive property and an insulating property, and is comprised of a glass substrate or a quarts substrate, for example. The inorganic insulating layer 32 has a transmissive property and an insulating property, and is made of an inorganic material including silicon such as silicon oxide, for example. The common electrode 33 is a counter electrode disposed relative to the plurality of pixel electrodes 25 with the liquid crystal layer 5 being interposed between them. The common electrode 33 is used to apply an electric field to the liquid crystal layer 5. The common electrode 33 has a transmissive property and an electrical conductivity. The common electrode 33 includes a transparent conductive material such as ITO, IZO, or FTO, for example. The orientation film 34 has a transmissive property and an insulating property. The orientation film 34 causes liquid crystal molecules that the liquid crystal layer 5 includes, to be oriented. The orientation film 34 is made of a material such as polyimide or silicon oxide, for example.

The sealing member 4 is disposed between the first substrate 2 and the second substrate 3 to seal a space between the first substrate 2 and the second substrate 3. The sealing member 4 is formed by using an adhesive or the like containing various types of curable resin such as epoxy resin, for example. The sealing member 4 may include a gap material including an inorganic material such as glass.

The liquid crystal layer 5 is arranged within a region surrounded by the first substrate 2, the second substrate 3, and the sealing member 4. The liquid crystal layer 5 is an electro-optical layer of which optical characteristics change depending on an electric field. The liquid crystal layer 5 includes liquid crystal molecules having positive or negative dielectric anisotropy. The orientation of the liquid crystal molecules changes depending on a voltage applied to the liquid crystal layer 5.

A plurality of scanning-line drive circuits 11, a peripheral circuit 12, and a plurality of external terminals 13 are disposed in the first substrate 2 as illustrated in FIG. 1. A portion of the plurality of external terminals 13 is coupled to wiring lines (not illustrated) laid from the scanning-line drive circuit 11 or the peripheral circuit 12. In addition, the plurality of external terminals 13 include a terminal to which a constant potential Vcom is applied. This terminal is electrically coupled to the common electrode 33 of the second substrate 3 through a wiring line and a conductive member, which are not illustrated. With this configuration, the constant potential Vcom is supplied to the common electrode 33.

The electro-optical device 100 includes a display region A10 configured to display an image, and a peripheral area A20 located outside the display region A10 in plan view. A plurality of pixels P arrayed in a matrix manner are provided in the display region A10. The plurality of pixel electrodes 25 are disposed in a one-to-one relationship with the plurality of pixels P. The common electrode 33 described above is provided in common for the plurality of pixels P. In addition, the peripheral area A20 surrounds the display region A10 in plan view. The scanning-line drive circuit 11 and the peripheral circuit 12 are disposed in the peripheral area A20.

In the present embodiment, the electro-optical device 100 is of a transmissive type. Specifically, light LL enters the second substrate 3 and is modulated before being outputted from the first substrate 2 as illustrated in FIG. 2, whereby an image is displayed. Note that an image may be displayed as the light is modulated during the time when the light enters the first substrate 2 and then is outputted from the second substrate 3.

Furthermore, the electro-optical device 100 is applied to, for example, a display device that performs color display, such as a personal computer, a smartphone, or the like, which will be described later. When the electro-optical device 100 is applied to the display device, a color filter is used for the electro-optical device 100 on an as-necessary basis. In addition, the electro-optical device 100 is applied, for example, to a projection-type projector that will be described later. In this case, the electro-optical device 100 functions as a light valve. Note that, in this case, the color filter is not used for the electro-optical device 100.

### A2. Electrical Configuration in Pixel P

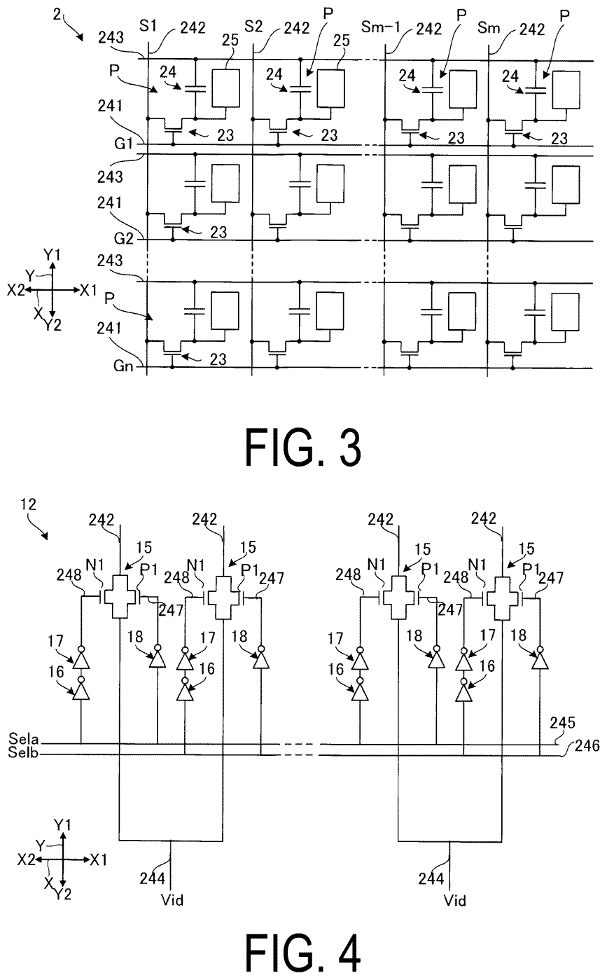

FIG. 3 is an equivalent circuit diagram illustrating the electrical configuration of pixels P in FIG. 1. As illustrated in FIG. 3, the first substrate 2 includes a plurality of transistors 23, n pieces of scanning lines 241, m pieces of data lines 242, and n pieces of constant potential lines 243. Each of “n” and “m” is an integer equal to or more than 2. Transistors 23 are disposed so as to correspond to individual intersections of the n pieces of scanning lines 241 and the m pieces of data lines 242. Each of the transistors 23 is a thin film transistor (TFT) that functions as a switching element, for example. Each of the transistors 23 includes a gate, a source, and a drain.

The n pieces of scanning lines 241 each extend in the X1 direction, and the n pieces of scanning lines 241 each extend in the Y2 direction. The n pieces of scanning lines 241 are each electrically coupled to the gate of the corresponding transistor 23. The n pieces of scanning lines 241 are electrically coupled to the scanning-line drive circuit 11 illustrated in FIG. 1. One to n pieces of scanning lines 241 are line-sequentially supplied with scanning signals G1, G2, . . . , and Gn from the scanning-line drive circuit 11.

The m pieces of data lines 242 illustrated in FIG. 3 each extend in the Y1 direction. The m pieces of data lines 242 are arrayed at equal intervals in the X1 direction. The m pieces of data lines 242 are each electrically coupled to the source of the corresponding transistor 23. The m pieces of data lines 242 are electrically coupled to the peripheral circuit 12 illustrated in FIG. 1. One to m pieces of data lines 242 are supplied in parallel with image signals S1, S2, . . . , and Sm from the peripheral circuit 12.

The n pieces of scanning lines 241 and the m pieces of data lines 242 illustrated in FIG. 3 are electrically insulated from each other, and are arrayed in a lattice form in plan view. A region surrounded by two adjacent scanning lines 241 and two adjacent data lines 242 corresponds to a pixel P. The transistor 23, the pixel electrode 25, and the capacitance element 24 are provided for each pixel P. The pixel electrode 25 is provided in a one-to-one relationship with the transistor 23. Each pixel electrode 25 is electrically coupled to the drain of the corresponding transistor 23.

The n pieces of constant potential lines 243 each extend in the X1 direction. The n pieces of constant potential lines 243 are arrayed at equal intervals in the Y2 direction. In addition, the n pieces of constant potential lines 243 are electrically insulated from the n pieces of scanning lines 241 and the m pieces of data lines 242, and are disposed so as to be spaced apart from the n pieces of scanning lines 241 and the m pieces of data lines 242. The constant potential Vcom is applied to each of the constant potential lines 243. Each of the n pieces of constant potential lines 243 is electrically coupled to one of two electrodes that the corresponding capacitance element 24 includes. Each of the capacitance element 24 is a retention capacitor used to retain a potential of the pixel electrode 25. The capacitance element 24 is provided in a one-to-one relationship with the transistor 23. In addition, the other one of the two electrodes that each of the capacitance elements 24 includes is electrically coupled to the corresponding pixel electrode 25. Thus, the constant potential Vcom is applied to one electrode of the capacitance element 24 whereas the other electrode is electrically coupled to the drain of the transistor 23.

When the scanning signals G1, G2, . . . , and Gn sequentially become active and the n pieces of scanning lines 241 are sequentially selected, the transistor 23 coupled to the selected scanning line 241 turns into an ON state. Then, the image signals S1, S2, . . . , and Sm having the size corresponding to the gray-scale to be displayed are taken into the pixel P corresponding to the selected scanning line 241 through the m pieces of data lines 242, and are applied to the pixel electrode 25. With this configuration, a voltage corresponding to the gray-scale to be displayed is applied to a liquid crystal capacitor formed between the pixel electrode 25 and the common electrode 33 in FIG. 2, and the orientation of the liquid crystal molecules changes in accordance with the applied voltage. In addition, the applied voltage is retained by the capacitance element 24. Such a change in the orientation of the liquid crystal molecules makes it possible to modulate the light to perform gray-scale display.

### A3. Electrical Configuration at Peripheral Circuit 12

FIG. 4 is a diagram illustrating an electrical configuration of the peripheral circuit 12 illustrated in FIG. 1. The peripheral circuit 12 illustrated in FIG. 4 is a circuit configured to distribute a data signal to the data line 242 in accordance with a selection signal. The peripheral circuit 12 includes, for each data line 242, a transmission gate 15, NOT circuits 16 and 17, and a NOT circuit 18.

The transmission gate 15 is an analog switch in which a P-channel type transistor P1 and an N-channel type transistor N1 are coupled in parallel. Each of the P-channel type transistor P1 and the N-channel type transistor N1 is a thin membrane transistor.

The transmission gate 15 includes an input terminal coupled to the data signal line 244. The transmission gate 15 includes an output terminal coupled to the data line 242. For example, one data line 242 is coupled, as a common line, to two transmission gates 15 corresponding to three data signal lines 244. Note that one data line 242 may be coupled, as a common line, to three or more transmission gates 15.

This transmission gate 15 is an element configured to write, into the data line 242, a data signal Vid supplied to the data signal line 244. The data signal Vid supplied from the data signal line 244 is a signal used to supply, in a time-division manner in a horizontal scanning period, a potential corresponding to gray-scale of three corresponding pixels and horizontally scanned by three data lines 242 corresponding to the data signal line 244.

The NOT circuits 16 and 17 are electrically coupled, through a wiring line 248, to the gate of the N-channel type transistor N1 of the transmission gate 15. The NOT circuit 16 is configured to invert a logical level of a selection signal Sela or Selb to output it. The NOT circuit 17 is configured to re-invert the logical level of the signal inverted by the NOT circuit 16 to output it. That is, the NOT circuits 16 and 17 are buffer circuits configured to buffer the logical level of the selection signal Sela or Selb. Note that the NOT circuit 17 supplies the buffered selection signal Sela or Selb to the gate of the N-channel type transistor N1 of the transmission gate 15.

The NOT circuit 18 is electrically coupled, through a wiring line 247, to the gate of the P-channel type transistor P1 of the transmission gate 15. The NOT circuit 18 inverts the logical level of the selection signal Selb to supply it to the gate of the P-channel type transistor P1 of the transmission gate 15.

Note that the selection signals Sela and Selb are signals used to select the data line 242. The selection signals Sela and Selb are supplied through a selection signal line 245 or 246.

As described above, the transmission gate 15 is configured such that the P-channel type transistor P1 and the N-channel type transistor N1 are coupled in parallel. In this transmission gate 15, the P-channel type transistor P1 and the N-channel type transistor N1 turn into the ON state at the same time. Thus, the on resistance is almost half of that in a mode comprised only of either one of the P-channel type transistor P1 and the N-channel type transistor N1. In addition, when the data signal Vid has a positive polarity at the transmission gate 15, the P-channel type transistor P1 compensates for the insufficient writing of the N-channel type transistor N1. On the other hand, when the data signal Vid has a negative polarity, the N-channel type transistor N1 compensates for the insufficient writing of the P-channel type transistor P1. For this reason, by using the transmission gate 15, it is possible to suppress display irregularity caused by a difference in polarity. Thus, in order to increase the resolution, it is preferable to use the transmission gate 15 as an element configured to write, into the data line 242, the data signal Vid supplied to the data signal line 244.

### A4. Configuration of Transmission Gate 15

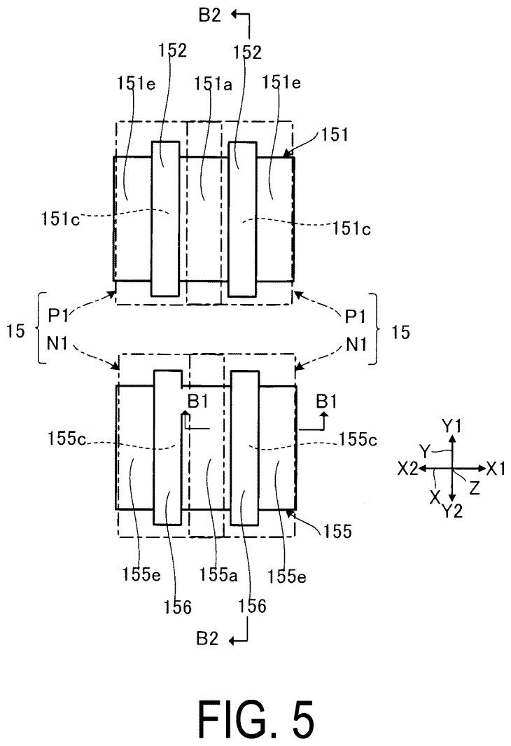

FIG. 5 is a plan view illustrating the configuration of the transmission gate 15 illustrated in FIG. 4. As illustrated in FIG. 15, the P-channel type transistor P1 and the N-channel type transistor N1 that each of the transmission gates 15 includes are arrayed along the Y1 direction that is the direction in which each of the data signal line 244 and the data line 242 described above extends. In addition, in the example in FIG. 5, two transmission gates 15 are partially share with each other.

The P-channel type transistor P1 includes a semiconductor layer 151, a gate electrode 152, and a gate insulating film. Note that this gate insulating film is disposed between the semiconductor layer 151 and the gate electrode 152, and is not illustrated in FIG. 5. The semiconductor layer 151 includes, at least, a source/drain region 151a, a channel area 151c, and a source/drain region 151e. The source/drain region 151a is electrically coupled to the data signal line 244. The source/drain region 151e is electrically coupled to the data line 242. Note that the semiconductor layer 151 may have a lightly doped drain (LDD) structure. In this case, the semiconductor layer 151 may further include a low-density drain area and a low-density source area.

Similarly, the N-channel type transistor N1 includes a semiconductor layer 155, a gate electrode 156, and a gate insulating film. Note that the gate insulating film is disposed between the semiconductor layer 155 and the gate electrode 156, and is not illustrated in FIG. 5. The semiconductor layer 155 includes a source/drain region 155a, a channel area 155c, and a source/drain region 155e. The source/drain region 155a is electrically coupled to the data signal line 244. The source/drain region 155e is electrically coupled to the data line 242. Note that the semiconductor layer 151 may have a lightly doped drain (LDD) structure. In this case, the semiconductor layer 151 may further include a low-density drain area and a low-density source area.

In the example illustrated in FIG. 5, two transmission gates 15 are partially shared with each other. Specifically, the source/drain region 151a of the P-channel type transistor P1 that two transmission gates 15 include are shared, and the source/drain region 151e is independent. Similarly, the source/drain region 155a of the N-channel type transistor N1 that two transmission gates 15 include are shared, and the source/drain region 155e is independent.

Note that the “source/drain region” as used herein means a region including any one of the source and the drain. For example, when the source/drain region 155a is the source area, the source/drain region 155e is the drain area.

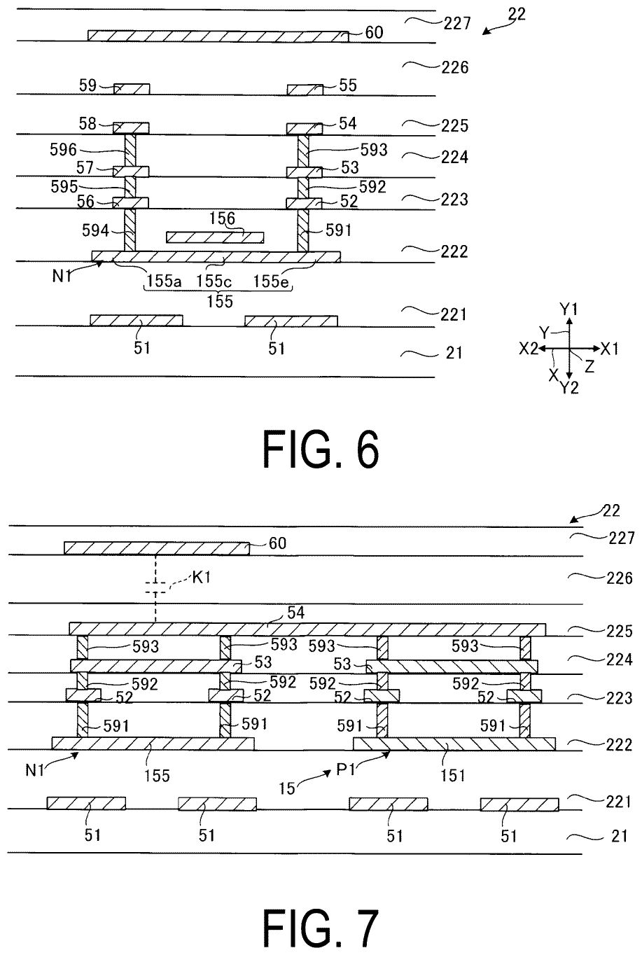

FIG. 6 is a diagram corresponding to the cross section taken along the B1-B1 line in FIG. 5. FIG. 7 is a diagram corresponding to the cross section taken along the B2-B2 line in FIG. 5. As illustrated in FIGS. 6 and 7, the stacked body 22 of the first substrate 2 includes a plurality of insulating layers 221 to 227 having a transmissive property. The insulating layers 221 to 227 are formed by using an inorganic material containing silicon such as silicon oxide or silicon oxynitride.

A plurality of lower-side light shielding sections 51 are provided at the substrate 21. The lower-side light shielding sections 51 are each disposed below the N-channel type transistor N1 or the P-channel type transistor P1, and overlap with them in plan view. The lower-side light shielding sections 51 each have a light shielding property, and are provided in order to prevent light from entering the N-channel type transistor N1 and the P-channel type transistor P1 from below. The lower-side light shielding sections 51 are each formed, for example, by using metal such as tungsten, aluminum, or titanium, an oxide of this metal, a nitride of this metal, or the like.

The N-channel type transistor N1 and the P-channel type transistor P1 are disposed at the insulating layer 221. The relay electrodes 52 and 56 are disposed at the insulating layer 222. The relay electrode 52 is coupled to the source/drain region 155e via a contact 591 penetrating through the insulating layer 222. The relay electrode 56 is coupled to the source/drain region 155a via a contact 594 penetrating through the insulating layer 222. In addition, relay electrodes 53 and 57 are disposed at the insulating layer 223. The relay electrode 53 is coupled to the relay electrode 52 via a contact 592 penetrating through the insulating layer 223. The relay electrode 57 is coupled to the relay electrode 56 via a contact 595 penetrating through the insulating layer 223.

Relay electrodes 54 and 58 are disposed at the insulating layer 224. The relay electrode 54 is coupled to the relay electrode 53 via a contact 593 penetrating through the insulating layer 224. The relay electrode 54 is electrically coupled to the data line 242 illustrated in FIG. 4. In addition, the relay electrode 57 is coupled to the relay electrode 56 via the contact 595 penetrating through the insulating layer 223. The relay electrode 57 is electrically coupled to the data signal line 244 illustrated in FIG. 4.

In addition, the relay electrodes 55 and 59 are disposed at the insulating layer 225. The relay electrode 55 is electrically coupled to the wiring line 247 via various types of relay electrodes and contacts that are not illustrated in FIGS. 6 and 7. The relay electrode 59 is electrically coupled to the wiring line 248 via various types of relay electrodes and contacts that are not illustrated in FIGS. 6 and 7.

In addition, a light shielding film 60 is disposed at the insulating layer 226.

### A5. Light Shielding Film 60

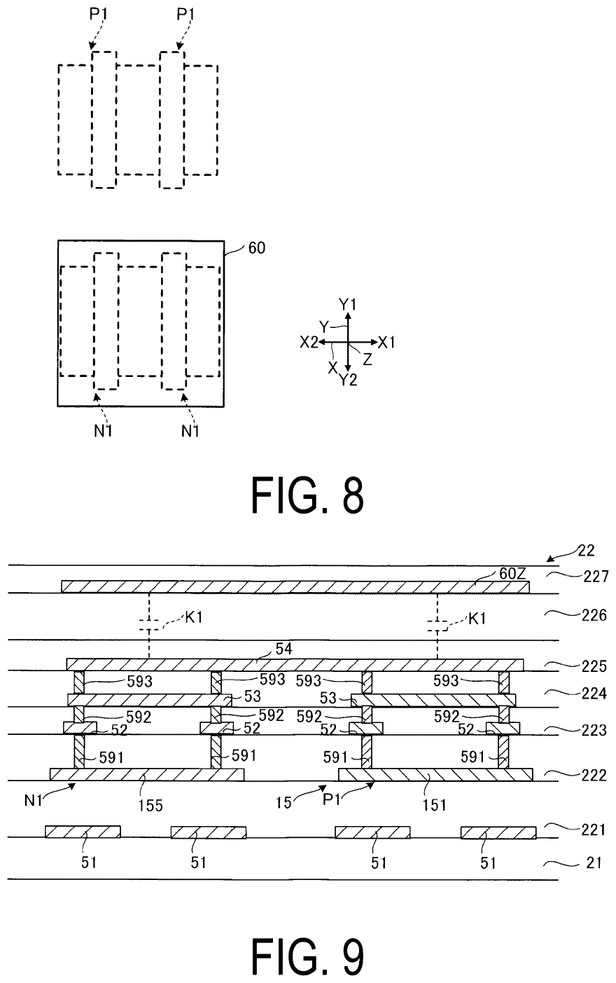

FIG. 8 is a diagram illustrating the light shielding film 60 illustrated in FIGS. 6 and 7. The light shielding film 60 having a light shielding property is disposed at the insulating layer 226 as illustrated in FIGS. 6 and 7. The light shielding film 60 is disposed above the N-channel type transistor N1 as illustrated in FIGS. 6, 7, and 8. Although covering the N-channel type transistor N1 in plan view, the light shielding film 60 does not cover the P-channel type transistor P1 in plan view.

The light shielding film 60 is formed by using a metal such as aluminum or titanium, an oxide of the metal, a nitride of the metal, or the like. In addition, the light shielding film 60 is configured as a single layer or a stacked body. The light shielding film 60 is provided in order to block light entering the transmission gate 15.

Here, the N-channel type transistor N1 and the P-channel type transistor P1, which the transmission gate 15 includes, may have different performances. As compared with the higher performance side of these transistors, the lower performance side may have a slow rising edge time of the selection signal including a digital signal waveform, that is, the rounding of the waveform may occur.

FIG. 9 is a diagram illustrating a light shielding film 60Z according to a comparative example. In the comparative example illustrated in FIG. 9, the light shielding film 60Z is disposed above the N-channel type transistor N1 and the P-channel type transistor P1. The light shielding film 60Z covers the N-channel type transistor N1 and the P-channel type transistor P1 in plan view.

When the light shielding film 60Z is provided so as to cover both of the N-channel type transistor N1 and the P-channel type transistor P1 as in the comparative example illustrated in FIG. 9, a capacitive coupling K1 occurring, for example, between the relay electrode 54 and the light shielding film 60Z is large. The relay electrode 54 corresponds to an “electrically conducting section.” Although the relay electrode 54 and the light shielding film 60 have potentials differing from each other, these elements are disposed close to each other. This results in occurrence of the capacitive coupling between these elements. That is, a potential difference that leads to formation of the capacitive coupling K1 exists between the light shielding film 60 and the relay electrode 54. Note that the light shielding film 60 is closer to the liquid crystal layer 5 than the relay electrode 54 in a direction along the Z-axis, and the relay electrode 54 is closer to the liquid crystal layer 5 than the transmission gate 15. Thus, the transmission gate 15, the relay electrode 54, and the light shielding film 60 are arranged in this order toward the liquid crystal layer 5 in the Z-axis.

As the capacitive coupling K1 increases, the rounding of the waveform described above at either one of the N-channel type transistor N1 and the P-channel type transistor P1 described above increases, as compared with that at the other one. Thus, the difference in rising edge time of the selection signal is large between the N-channel type transistor N1 and the P-channel type transistor P1.

For this reason, the present embodiment is configured such that the light shielding film 60 is not provided at the lower performance side of the N-channel type transistor N1 and the P-channel type transistor P1. This makes it possible to reduce the influence, on the lower performance side, of the capacitive coupling K1 occurring between the relay electrode 54 serving as an electrical conducting section and the light shielding film 60. Thus, it is possible to reduce the rounding of the waveform described above at the lower performance side. This makes it possible to reduce the difference in performance between the N-channel type transistor N1 and the P-channel type transistor P1. The reduction in the difference of the performance suppresses the insufficient writing of the data signal into the data line 242 during high-speed driving. Thus, it is possible to provide the electro-optical device 100 suitable for high-speed driving.

In particular, in the present embodiment, the light shielding film 60 overlaps with the N-channel type transistor N1 in plan view, and does not overlap with the P-channel type transistor P1 in plan view. The light shielding film 60 is provided at a location differing from that of the P-channel type transistor P1 in plan view. In general, the P-channel type transistor P1 has performance lower than the N-channel type transistor N1. Thus, the light shielding film 60 is configured to overlap with the N-channel type transistor N1 and not overlap with the P-channel type transistor P1 in plan view, which makes it possible to reduce the difference in performance between the N-channel type transistor N1 and the P-channel type transistor P1.

In addition, the light shielding film 60 has the constant potential Vcom, for example. As the light shielding film 60 has the constant potential Vcom, it is possible to suppress occurrence of noises, as compared with the light shielding film 60 not having the constant potential Vcom. Note that the light shielding film 60 may have a GND potential or a power supply potential, for example.

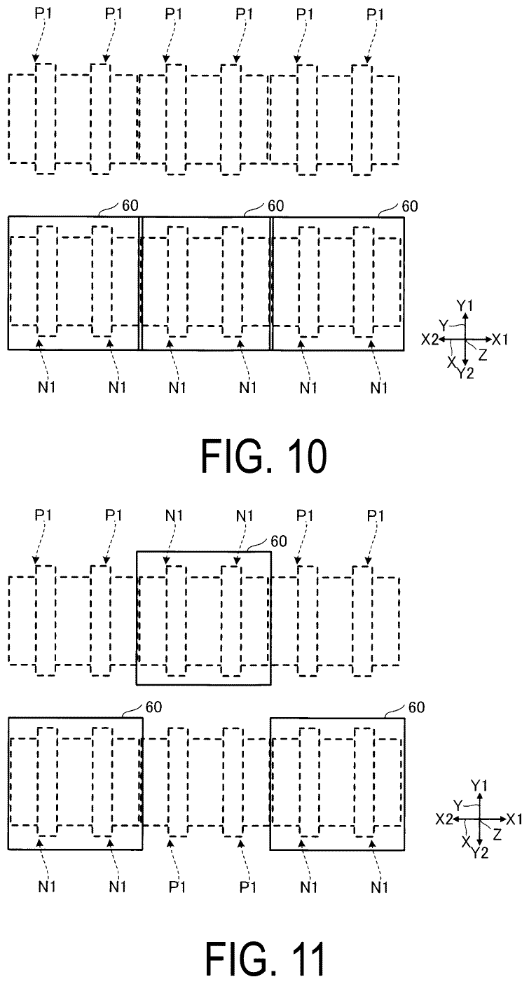

FIG. 10 is a plan view illustrating the layout of a plurality of light shielding sections 60 for a plurality of transmission gates 15 according to the first embodiment. In the present embodiment, the P-channel type transistor P1 and the N-channel type transistor N1 are each disposed along the Y1 direction for each of the transmission gates 15 as illustrated in FIG. 10. In addition, the plurality of P-channel type transistors P1 are arrayed along the X1 direction. The plurality of N-channel type transistors N1 are arrayed along the X1 direction. Thus, a plurality of the light shielding films 60 are arrayed along the X1 direction.

Note that, in FIG. 10, a plurality of light shielding films 60 are separately provided. However, the plurality of light shielding films 60 are integrally coupled to each other. As the plurality of light shielding films 60 are integrally provided, it is easy to manufacture them, as compared with a case where they are separately provided.

### B. Modification Example of First Embodiment

The first embodiment can be modified in various modes. Specific modification modes that are applicable to the first embodiment described above will be described below as examples. It is possible to combine, as appropriate, two or more any modes that are selected from the examples below as long as they do not contradict each other.

### B-1. First Modification Example

FIG. 11 is a plan view illustrating the layout of a plurality of the light shielding films 60 for a plurality of transmission gates 15 according to a first modification example. As illustrated in FIG. 11, in the first modification example, a plurality of P-channel type transistors P1 and a plurality of N-channel type transistors N1 are arrayed in a staggered manner in plan view. Thus, a plurality of light shielding films 60 are arrayed in a staggered manner in plan view. In this manner, the layout of the plurality of light shielding films 60 is configured so as to correspond to the layout of the transistors. Thus, there is no particular limitation as to the layout of them in plan view.

### B-2. Second Modification Example

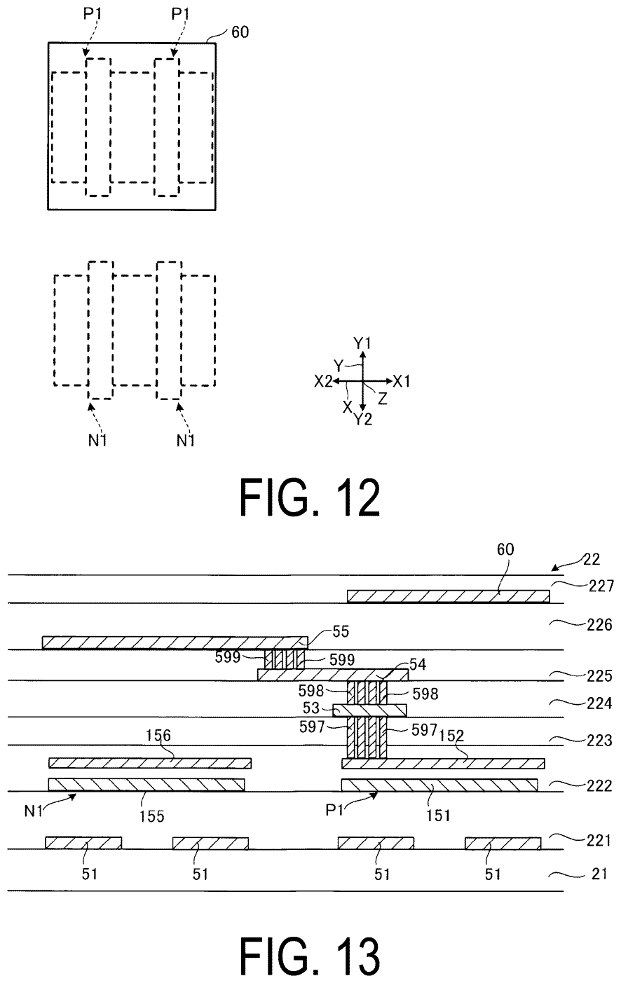

FIG. 12 is a plan view illustrating the light shielding film 60 according to the second modification example. FIG. 13 is a cross-sectional view illustrating the light shielding film 60 illustrated in FIG. 12. In the second modification example, the light shielding film 60 overlaps with the P-channel type transistor P1 in plan view, and does not overlap with the N-channel type transistor N1 in plan view, as illustrated in FIGS. 12 and 13.

As illustrated in FIG. 13, the gate electrode 152 of the P-channel type transistor P1 is electrically coupled to the relay electrode 53 via a plurality of contacts 597. In addition, the relay electrode 53 is electrically coupled to the relay electrode 54 via a plurality of contacts 598. In addition, the relay electrode 54 is electrically coupled to the relay electrode 55 serving as an electrically conducting section via a plurality of contacts 599.

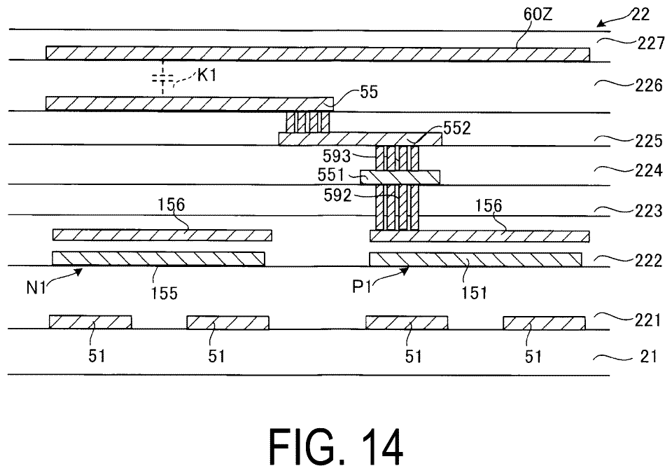

FIG. 14 is a diagram illustrating a light shielding film 60Z according to a comparative example. In the comparative example in FIG. 14, the light shielding film 60Z overlaps with the P-channel type transistor P1 and the N-channel type transistor N1 in plan view. In this case, due to the influence of a capacitive coupling K2 formed between the N-channel type transistor N1 and the relay electrode 55 provided directly below the N-channel type transistor N1, there is a possibility that the rising edge time of the selection signal supplied to the N-channel type transistor N1 is delayed. This results in an increase in a difference in the rising edge time of the selection signal between the N-channel type transistor N1 and the P-channel type transistor P1.

Note that, in the present comparative example, the relay electrode 55 is not provided directly below the P-channel type transistor P1. Thus, the influence of this capacitive coupling K2 is less likely to occur.

In view of the fact described above, the present comparative example is configured such that the light shielding film 60 overlaps with the P-channel type transistor P1 in plan view, and does not overlap with the N-channel type transistor N1 in plan view. This makes it possible to reduce the difference in performance between the P-channel type transistor P1 and the N-channel type transistor N1.

### C. Second Embodiment

In the second embodiment below, elements having functions similar to those in the first embodiment are denoted by the reference characters used in the description of the first embodiment, and explanation thereof will not be repeated on an as-necessary basis.

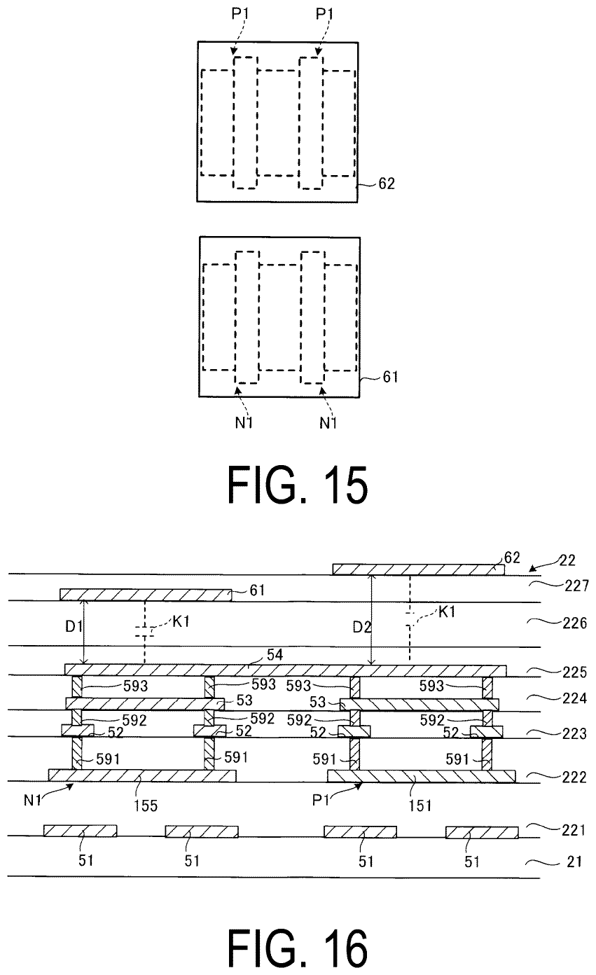

FIG. 15 is a plan view illustrating a first light shielding film 61 and a second light shielding film 62 according to the second embodiment. FIG. 16 is a cross-sectional view illustrating the first light shielding film 61 and the second light shielding film 62 illustrated in FIG. 15.

In the present embodiment, the first light shielding film 61 and the second light shielding film 62 are provided, instead of the light shielding film 60 according to the first embodiment. Note that the first light shielding film 61 and the second light shielding film 62 are closer to the liquid crystal layer 5 than the relay electrode 54, and the relay electrode 54 is closer to the liquid crystal layer 5 than the transmission gate 15. The transmission gate 15, the relay electrode 54, and the first light shielding film 61 are arranged in this order toward the liquid crystal layer 5 in the Z-axis. The transmission gate 15, the relay electrode 54, and the second light shielding film 62 are arranged in this order toward the liquid crystal layer 5 in the Z-axis.

The first light shielding film 61 overlaps with the N-channel type transistor N1 in plan view. The second light shielding film 62 overlaps with the P-channel type transistor P1 in plan view. In addition, the light shielding property of the first light shielding film 61 relative to the N-channel type transistor N1 is higher than the light shielding property of the second light shielding film 62 relative to the N-channel type transistor N1. This enables the capacitive coupling K1 between the relay electrode 54 and the P-channel type transistor P1 to be smaller than the capacitive coupling K1 between the relay electrode 54 and the N-channel type transistor N1. The reason that the capacitive coupling K1 is formed is because the first light shielding film 61 and the relay electrode 54 have potentials different from each other, and the second light shielding film 62 and the relay electrode 54 have potentials different from each other. That is, the first light shielding film 61 and the relay electrode 54 have a potential difference at which the capacitive coupling K1 is formed. The second light shielding film 62 and the relay electrode 54 have a potential difference at which the capacitive coupling K1 is formed.

By setting the light shielding property of the second light shielding film 62 to be lower than the light shielding property of the first light shielding film 61 in this manner, it is possible to suppress an increase in the rounding of the waveform at the P-channel type transistor P1 generally having the performance lower than the N-channel type transistor N1. This makes it possible to reduce the difference in performance between the N-channel type transistor N1 and the P-channel type transistor P1. By reducing the difference in performance, it is possible to suppress the insufficient writing of the data signal into the data line 242 during high-speed driving. Thus, it is possible to provide the electro-optical device 100 suitable for high-speed driving.

In addition, as described above, the distance D2 between the second light shielding film 62 and the relay electrode 54 is longer than the distance D1 between the first light shielding film 61 and the relay electrode 54. This makes it possible to set the light shielding property of the second light shielding film 62 to be lower than the light shielding property of the first light shielding film 61.

### D. Modification Example of Second Embodiment

The second embodiment can be modified in a various manner. Specific modification modes that are applicable to the first embodiment described above will be described below as examples. It is possible to combine, as appropriate, two or more any modes that are selected from the examples below as long as they do not contradict each other.

The distance D1 between the first light shielding film 61 and the relay electrode 54 is longer than the distance D2 between the second light shielding film 62 and the relay electrode 54. For example, from the viewpoint of reducing the influence of the capacitive coupling K2 as in FIG. 13, the distance D1 may be longer than the distance D2.

### D-1. Third Modification Example

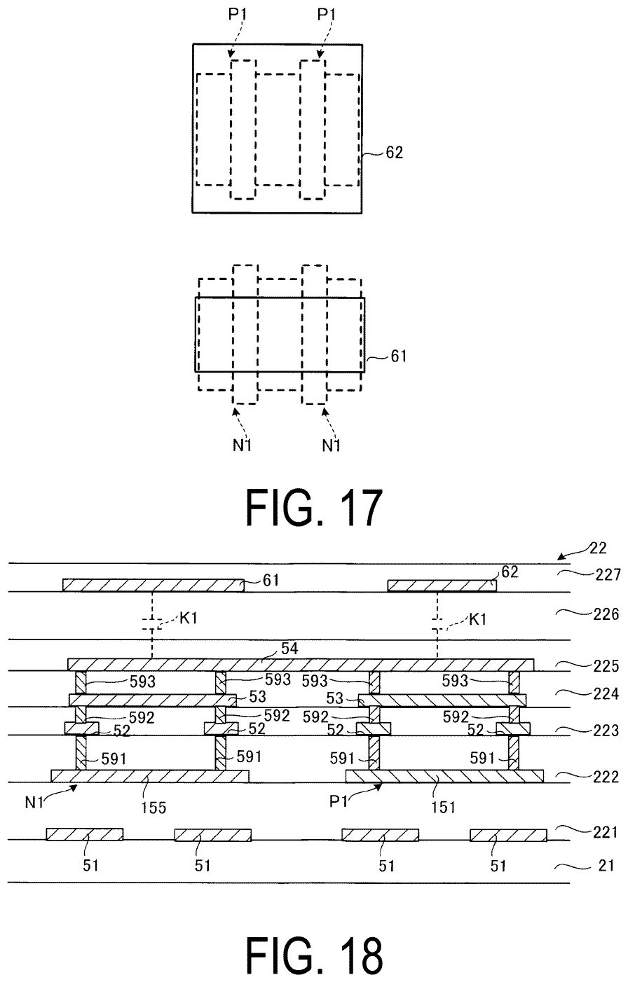

FIG. 17 is a plan view illustrating the first light shielding film 61 and the second light shielding film 62 according to the third modification example. FIG. 18 is a cross-sectional view illustrating the first light shielding film 61 and the second light shielding film 62 illustrated in FIG. 17. In the present comparative example, the first light shielding film 61 and the second light shielding film 62 are disposed at the same layer with each other, as illustrated in FIG. 18. In addition, as illustrated in FIG. 17, the degree of overlapping of the first light shielding film 61 relative to the N-channel type transistor N1 in plan view is lower than the degree of overlapping of the second light shielding film 62 relative to the P-channel type transistor P1 in plan view. Thus, it is possible to set the light shielding property of the second light shielding film 62 to be lower than the light shielding property of the first light shielding film 61.

As in the second embodiment, in the present modification example, the light shielding property of the first light shielding film 61 relative to the N-channel type transistor N1 is higher than the light shielding property of the second light shielding film 62 relative to the N-channel type transistor N1. This makes it possible to prevent the rounding of the waveform from increasing at the P-channel type transistor P1 generally having the performance lower than the N-channel type transistor N1. Thus, it is possible to reduce the difference in performance between the N-channel type transistor N1 and the P-channel type transistor P1.

Note that the degree of overlapping of the second light shielding film 62 relative to the P-channel type transistor P1 in plan view may be lower than the degree of overlapping of the first light shielding film 61 relative to the N-channel type transistor N1 in plan view. For example, from the viewpoint of reducing the influence of the capacitive coupling K2 as in FIG. 13, the degree of overlapping of the second light shielding film 62 described above may be lower than the degree of overlapping of the first light shielding film 61 described above.

### E. Modification Examples

The embodiments described above can be modified in various manner. Below, description will be made of specific modification modes applicable to the embodiments described above. It is possible to combine, as appropriate, two or more any modes that are selected from the examples below as long as they do not contradict each other.

In each of the embodiments described above, the electro-optical device 100 using an active matrix scheme is described. However, the scheme of the electro-optical device 100 is not limited to this, and a drive scheme of the electro-optical device 100 may be, for example, a passive matrix scheme or the like.

The driving scheme of the “electro-optical device” is not limited to a vertical electric field scheme, and a horizontal electric field scheme may be used. Note that the horizontal electric field scheme includes an in plane switching (IPS) mode, for example. In addition, the vertical electric field scheme includes a twisted nematic (TN) mode, a vertical alignment (VA), a PVA mode, and an optically compensated bend (OCB) mode.

### 2. Electronic Apparatus

The electro-optical device 100 can be used in various types of electronic apparatuses.

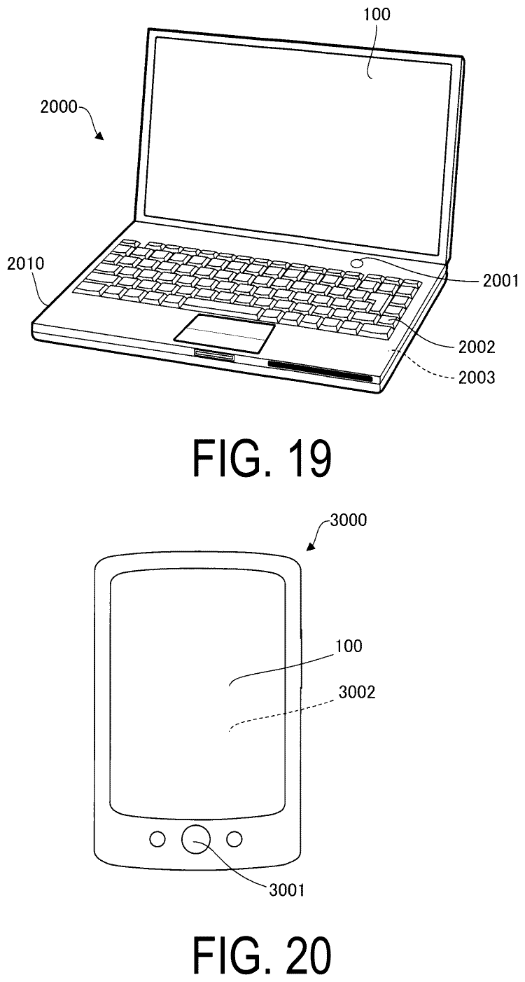

FIG. 19 is a perspective view illustrating a personal computer 2000 serving as one example of the electronic apparatus. The personal computer 2000 includes the electro-optical device 100 that displays various types of images, a main body unit 2010 in which a power switch 2001 and a keyboard 2002 are installed, and a control unit 2003. The control unit 2003 includes, for example, a processor and a memory, and controls operation of the electro-optical device 100.

FIG. 20 is a plan view illustrating a smartphone 3000 serving as one example of the electronic apparatus. The smartphone 3000 includes operation button 3001, the electro-optical device 100 that displays various types of images, and a control unit 3002. Screen details displayed on the electro-optical device 100 is changed according to operation of the operation button 3001. The control unit 3002 includes, for example, a processor and a memory, and controls operation of the electro-optical device 100.

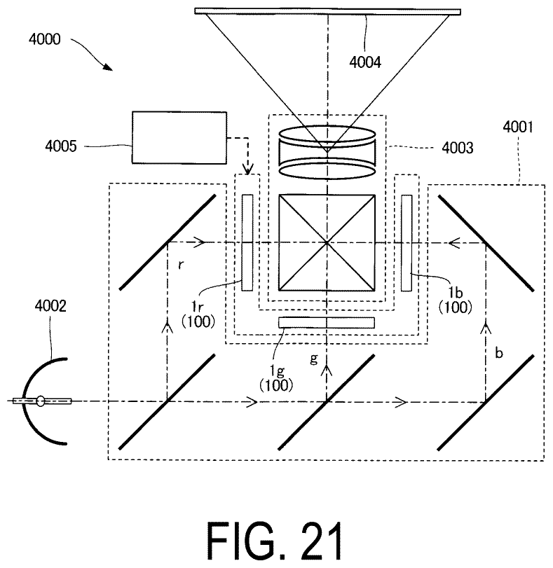

FIG. 21 is a schematic view illustrating a projector serving as one example of the electronic apparatus. A projection-type display device 4000 is, for example, a three-panel projector. The electro-optical device 1r is an electro-optical device 100 corresponding to a red display color. The electro-optical device 1g is an electro-optical device 100 corresponding to a green display color. The electro-optical device 1b is an electro-optical device 100 corresponding to a blue display color. That is, the projection-type display device 4000 includes three electro-optical devices 1r, 1g, and 1b each corresponding to a red display color, a green display color, and a blue display color. The control unit 4005 includes, for example, a processor and a memory, and controls operation of the electro-optical device 100.

An illumination optical system 4001 supplies a red color component r of the light emitted from an illumination apparatus 4002, which is a light source, to the electro-optical device 1r, supplies a green color component g to the electro-optical device 1g, and supplies a blue color component b to the electro-optical device 1b. Each of the electro-optical devices 1r, 1g, and 1b functions as an optical modulator such as a light valve that modulates each monochromatic light beam supplied from the illumination optical system 4001 in accordance with a display image. A projection optical system 4003 combines the light emitted from the respective electro-optical devices 1r, 1g, and 1b, and projects the combined light onto a projection surface 4004.

The electronic apparatuses described above include the electro-optical device 100 described above, and the control unit 2003, 3002, or 4005. The electro-optical device 100 described above is suitable for high-speed driving. Thus, by including the electro-optical device 100, it is possible to drive the personal computer 2000, the smartphone 3000, and the projection-type display device 4000 at a high speed.

Note that the electronic apparatus to which the electro-optical device according to the present disclosure is applied is not limited to the apparatuses described above, and also include a personal digital assistants (PDA), a digital still camera, a television, a video camera, a car navigation device, a vehicle mounted display unit, an electronic notebook, an electronic paper, a calculator, a word processor, a workstation, a videophone, and a point of sale (POS) terminal, or the like, for example. In addition, the electronic apparatus to which the present disclosure is applied includes a printer, a scanner, a copier, a video player, a device including a touch panel, and the like.

The present disclosure has been described on the basis of the preferred embodiments. However, the present disclosure is not limited to the above-described embodiments. In addition, the configuration of the respective portions of the present disclosure can be replaced with any configuration that performs the same function as that in the embodiments described above, or any configuration can be added.

Furthermore, in the description above, the liquid crystal display device has been described as one example of the electro-optical device of the present disclosure. However, the electro-optical device of the present disclosure is not limited to this. For example, the electro-optical device of the present disclosure can be applied to an image sensor, or the like.

What is claimed is:

1. An electro-optical device comprising:
a first substrate;
a second substrate;
an electro-optical layer disposed between the first substrate and the second substrate;
a display region including a plurality of pixels; and
a peripheral area provided outside the display region, wherein
the first substrate includes:
a transmission gate including an N-channel type transistor and a P-channel type transistor;
an electrical conducting section closer to the electro-optical layer than the transmission gate; and
a light shielding film closer to the electro-optical layer than the electrical conducting section, and
the light shielding film overlaps with one of the N-channel type transistor and the P-channel type transistor in plan view, and does not overlap with the other one of the N-channel type transistor and the P-channel type transistor in plan view.

2. The electro-optical device according to claim 1, wherein
the light shielding film and the electrical conducting section have potentials differing from each other.

3. The electro-optical device according to claim 1, wherein the light shielding film has a constant potential.

4. The electro-optical device according to claim 1, wherein
the N-channel type transistor overlaps with the light shielding film and the electrical conducting section in plan view, and
the P-channel type transistor does not overlap with the light shielding film in plan view.

5. An electro-optical device comprising:
a first substrate;
a second substrate;
an electro-optical layer disposed between the first substrate and the second substrate;
a display region including a plurality of pixels; and
a peripheral area provided outside the display region, wherein
the first substrate includes:
a transmission gate including an N-channel type transistor and a P-channel type transistor;
an electrical conducting section closer to the electro-optical layer than the transmission gate;
a first light shielding film closer to the electro-optical layer than the electrical conducting section; and
a second light shielding film closer to the electro-optical layer than the electrical conducting section,
the first light shielding film overlaps with the N-channel type transistor in plan view,
the second light shielding film overlaps with the P-channel type transistor in plan view, and
either one of the first light shielding film and the second light shielding film has a light shielding property lower than a light shielding property of the other one.

6. The electro-optical device according to claim 5, wherein
the first light shielding film and the electrical conducting section have potentials differing from each other, and
the second light shielding film and the electrical conducting section have potentials differing from each other.

7. The electro-optical device according to claim 5, wherein
the first light shielding film and the second light shielding film each have a constant potential.

8. The electro-optical device according to claim 5, wherein
the first light shielding film has a light shielding property higher than a light shielding property of the second light shielding film.

9. The electro-optical device according to claim 5, wherein
a distance between the electrical conducting section and either one of the first light shielding film and the second light shielding film is longer than a distance between the other one and the electrical conducting section.

10. The electro-optical device according to claim 5, wherein
the first light shielding film and the second light shielding film are disposed at an identical layer, and
either one of a degree of overlapping of the first light shielding film relative to the N-channel type transistor in plan view and a degree of overlapping of the second light shielding film relative to the P-channel type transistor in plan view is lower than the other one.

11. An electronic apparatus comprising:
the electro-optical device according to claim 1, and
a control unit configured to control operation of the electro-optical device.
